(19) United States
(12) Patent Application Publication
(10) Pub. No.: US 2026/0161778 A1
(43) Pub. Date: Jun. 11, 2026

(54) DATA SECURITY MANAGEMENT

(71) Applicant: Honeywell International Inc., Charlotte, NC (US)

(72) Inventors: Ravikumar Selvarajan, Madurai (IN); Sreenivasan Govindillam, Bangalore (IN); Sri Harsha Kosuri, Bangalore (IN)

(21) Appl. No.: 19/077,056

(22) Filed: Mar. 12, 2025

(30) Foreign Application Priority Data
Dec. 6, 2024 (IN) 202411096638

(51) Int. Cl. G06F 21/55; B64D 45/00

(52) U.S. Cl. CPC G06F 21/554; B64D 45/00; G06F 2221/034

(57) ABSTRACT

Techniques for managing security of input data to be used with avionics are described. In one example implementation, the present subject matter facilitates in processing of the input data at different flight plan applications and determining a confidence level of the output data at different flight plan applications depending on a degree of agreement between the output data. Further, using the output data for calculating flight modification parameters if the output data is not corrupted.

### BACKGROUND

Aerial vehicles, such as passenger aircrafts, cargo aircrafts, fighter aircrafts, artificial satellites, and spacecrafts, etc., generally comprise avionics that performs various functions, for example, communication, navigation, display, and data management. The avionics installed in the aerial vehicles may include, but is not limited to, flight management systems, engine controls, flight control systems, navigation, communications, flight recorders, lighting systems, threat detection, fuel systems, electro-optic systems, weather radar, etc. For example, the flight management system may collect, manage, protect, and store data such as flight path, a traffic diversion status, a cargo weight, etc, to perform functioning such as flight plan, position determination, guidance, vertical navigation, etc.

### SUMMARY OF INVENTION

This summary is provided to introduce concepts related to managing security of input data received from a user, for example, a pilot and to be used with avionics without any pilot review. This summary is not intended to identify essential features of the claimed subject matter nor is it intended for use in determining or limiting the scope of the claimed subject matter.

In an aspect of the present subject matter, a method for managing security of input data received from a user, for example, a pilot and to be used with avionics without any pilot review is disclosed. The method includes obtaining an input data. The input data is associated with at least one of flight assistance parameters of an aircraft. The flight assistance parameters ensure optimal and safe flight of the aircraft. Further, in the method, the input data is processed at each of a predetermined number of flight plan applications. At least one flight plan application, from among the predetermined number of flight plan applications, is heterogeneous with respect to other flight plan applications. In an example, all flight plan applications may be heterogeneous. The method further includes obtaining an output data from each of the flight plan applications and further determining a confidence level of the output data depending on a degree of agreement between the output data. The confidence level is associated with a data acceptability level indicating whether the output data is acceptable for further usage. For the output data determined to have the confidence level in a prespecified threshold, flight modification parameters are calculated using the output data and the flight modification parameters are further transmitted to a flight management system of the aircraft.

In another aspect of the present subject matter, a system for managing security of input data received from a user, for example, a pilot and to be used with avionics without any pilot review is disclosed. The system includes a data processing engine and a flight parameter generation engine. The data processing engine may obtain an input data. The input data is associated with at least one of flight assistance parameters of an aircraft. The flight assistance parameters ensure optimal and safe flight of the aircraft. Further, the data processing engine processes the input data at each of a predetermined number of flight plan applications. At least one flight plan application, from among the predetermined number of flight plan applications, is heterogeneous with respect to other flight plan applications. In an example, all flight plan applications may be heterogeneous. The data processing engine further obtains an output data from each of the flight plan applications and thereafter determines a confidence level of the output data depending on a degree of agreement between the output data. The confidence level is associated with a data acceptability level indicating whether the output data is acceptable for further usage. Further, the flight parameter generation engine, for the output data determined to have the confidence level in a prespecified threshold, calculates flight modification parameters the output data. The flight parameter generation engine transmits the calculated flight modification parameters to a flight management system of the aircraft.

In yet another aspect of the present subject matter, a non-transitory computer readable medium for managing security of input data received from a user, for example, a pilot and to be used with avionics without any pilot review is disclosed. The non-transitory computer readable medium has instructions stored thereon. The instructions, when executed by a processor, cause the processor to perform operations. In the operations, an input data is obtained. The input data is associated with at least one of flight assistance parameters of an aircraft. The flight assistance parameters ensure optimal and safe flight of the aircraft. Further, in operation, the input data is processed at each of a predetermined number of flight plan applications. At least one flight plan application, from among the predetermined number of flight plan applications, is heterogeneous with respect to other flight plan applications. In an example, all flight plan applications may be heterogeneous. Yet further, in the operations, an output data is obtained from each of the flight plan applications and further a confidence level of the output data is determined depending on a degree of agreement between the output data. The confidence level is associated with a data acceptability level indicating whether the output data is acceptable for further usage. Further, in operation, for the output data determined to have the confidence level in a prespecified threshold, flight modification parameters are calculated using the output data and the flight modification parameters are further transmitted to a flight management system of the aircraft.

### BRIEF DESCRIPTION OF FIGURES

Systems and/or methods, in accordance with examples of the present subject matter are now described and with reference to the accompanying figures, in which:

FIG. 1 illustrates a system for managing security of data to be used with avionics, according to an example;

FIG. 2 illustrates a network environment for managing security of data to be used with avionics, according to an example;

FIG. 3 illustrates a method for managing security of data to be used with avionics, according to an example;

FIG. 4 illustrates verification of a nearby waypoint, according to an example;

FIG. 5 illustrates a scenario when output data is rejected, according to another example;

FIG. 6 illustrates determination of confidence level, according to another example;

FIG. 7 illustrates a feedback methodology, according to an example;

FIG. 8 illustrates an environment where an aircraft is at a runway before takeoff, according to an example;

FIG. 9 illustrates an environment where an aircraft is flying and simultaneously interacting with a ground fleet service platform located at ground, according to an example;

FIG. 10 illustrates an environment where an input data is processed through three flight plan applications, according to an example; and

FIG. 11 illustrates a non-transitory computer readable medium for managing security of data to be used with avionics, according to an example.

### DETAILED DESCRIPTION

In recent years, avionics have become increasingly interconnected, both internally and with external open-source systems, such as, an electronic flight bag (EFB) which is an external management device to assist flight crews in flight management. The EFB may include EFB applications containing data that may include flight assistance parameters of an aerial vehicle, such as real-time weather details, navigational charts, and other data such as flight crew operating manuals, etc. Such interconnectivity allows the pilot to push-in input data associated with updated flight plans to the avionics for more efficient operation and management of an aircraft. In an example, applications such as voice enabled cockpit allows the pilot to string flight plans or modifications to flight plans due to instructions from air traffic control in the EFB.

However, the input data has safety concerns because the input data may be from an open-source environment and is therefore uncertified unlike data of the avionics. Such input data may be corrupted before it reaches the avionics, for example, due to virus attack. When any corrupted input data is fed to the avionics, possibilities of potential vulnerabilities, for example, cyber threats open for the avionics, thereby affecting integrity, functionality, availability, and robustness of the avionics. For example, incorrect navigation chart may cause unnecessary delay in a flight by modifying a flight path of the aerial vehicle.

In a conventional solution to verify the authenticity of the input data, each input data must be manually reviewed and approved by the pilot before the avionics (for example, the flight management system) can use the input data for updating the flight plan. Such a manual review and approval by the pilot is tedious and time-consuming. At times, the input data may not be reviewed by the pilot and thus not used by the avionics because of the tedious and time-consuming manual review and approval process. Thus, the operation of the aerial vehicle may not improve as would have if the input data had been utilized by the avionics. Thus, the efficiency of the avionics is affected.

The present subject matter describes approaches for managing security of input data received from a pilot and to be used with avionics without any pilot review. According to an implementation of the present subject matter, an input data is obtained. For example, in case of a connected flight management system, the pilot may push-in flight plans or changes to the connected flight management system, such as using an audio input as the input data. The input data is associated with a flight assistance parameter of an aircraft such as real-time weather information which may be obtained from a network. Further, the obtained input data is processed at each of a predetermined number of flight plan applications. In an example, the flight plan applications are EFB applications. The flight plan applications may be included in a portable electronic device such as a laptop or tablet which may be connected to the network. In an example, at least one flight plan application, from among the predetermined number of flight plan applications, is heterogeneous with respect to other flight plan applications. In an example, all the flight plan applications may be heterogeneous. The heterogenous processing of the input data increases the trust level that avionics can place on the data sourced from flight plan applications, i.e., EFB applications. Each flight plan application independently processes the input data, and output data is obtained from each of the flight plan applications. Before transmitting the processed data, i.e., output data to the avionics, the output data is checked to confirm the authenticity of the output data so that the avionics can be prevented from receiving any corrupted data.

For checking the output data authenticity, a confidence level of the output data may be determined depending on a degree of agreement between the output data. The confidence level is associated with a data acceptability level. The higher is the confidence level, the higher is the data acceptability level and lower is the chance that the output data is corrupted or compromised. In an example, the degree of agreement is directly proportional to the confidence level. On the other hand, the lower confidence level is an indicative that the output data that may include a malicious program, modified data, etc., which on execution may cause irregularity in the functioning of the avionics, i.e. flight management system. Such a heterogenous processing of the input data and further authenticating of the output data may be initiated manually by a user, i.e. pilot of the aircraft or may be initiated automatically when the portable device connects to the flight management system.

Further, for the output data determined to have the confidence level in a prespecified threshold, the processed output data is received from the flight management system. In an example, if the output data from all sources, i.e., all the flight plan applications agree with each other with a confidence level of 100%, the output data is accepted for further processing. Further, flight modification parameters are calculated using the processed output data. The flight modification parameters are transmitted to the flight management system of the aircraft for continuing optimal flight operation of the aircraft.

In an example, for the output data determined to have the confidence level below the prespecified threshold indicating that a degree of disagreement is present, a nearby waypoint to the output data is verified to authenticate context sensitivity of the output data. The nearby waypoint is an indicator associated with a flight plan summary including, but is not limited to, one or more fuel, distance, travel route, and travel time. On determining that the output data is authentic, flight modification parameters may be calculated using the output data and further transmitted to the flight management system of the aircraft. Otherwise, the output data is rejected to ensure that transmission of the compromised output data to the flight management system of the aircraft is prevented.

In an example, if the output data from all sources, i.e., all the flight plan applications completely disagree with each other, the output data is rejected.

In an example, an authenticity weightage may be assigned to the flight plan application depending on feedback on the authenticity of the output data received from said flight plan application. The authenticity weightage may be utilized subsequently while ascertaining the authenticity of the output data received from said flight plan application.

The present invention thus increases the trust level that avionics can place on the input data sourced from the EFB applications and hence paves way for high connectivity between the EFB applications and the avionics. The present invention enables heterogeneous processing of the input data by providing more than one source or path for the same data and cross validating the output data received from multi-source and multi-path by determining the confidence level. Such as approach increases the overall integrity of the data and minimizes common mode path errors as different paths employ different ways of processing. The present invention allows automatic validation and acceptance of authentic commands without pilot review. As a result, the efficiency of the avionics is not affected as well as the security is not compromised

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

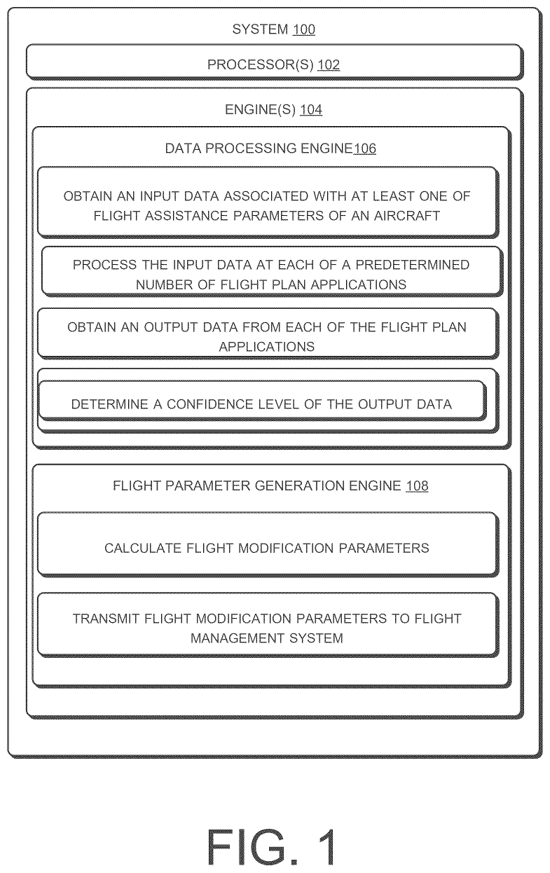

FIG. 1 illustrates a system 100 for managing security of input data received from a user, for example, pilot and to be used with avionics installed in an aerial vehicle (not shown in FIG. 1) without any pilot review, according to an example. Examples of the system 100 may include, but are not limited to, a laptop, a notebook computer, a server computer, a tablet computer, and a smartphone. The system 100 may include processor(s) 102. The processor(s) 102 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labelled as “processor(s)”, may be provided through the use of dedicated hardware as well as hardware capable of executing computer-readable instructions. In one example, the system 100 may be a standalone server or may be a remote server on a cloud computing platform. In a preferred example, the system 100 may be a cloud-based system. The system 100 is capable of delivering applications (such as cloud applications) for managing an aerial vehicle environment. Examples of the one or more avionics installed in the aerial vehicles may include, but is not limited to, flight management systems, engine controls, flight control systems, navigation, communications, flight recorders, lighting systems, threat detection, fuel systems, electro-optic systems, weather radar, etc. The system 100 may connect with one or more avionics.

The system 100 may further include engine(s) 104. The engine(s) 104 may be implemented as a combination of hardware and programming, for example, programmable instructions to implement a variety of functionalities of the engine(s) 104. In examples described herein, such combinations of hardware and programming may be implemented in several different ways. For example, the programming for the engine(s) 104 may be executable instructions. Such instructions may be stored on a non-transitory machine-readable storage medium which may be coupled either directly with the system 100 or indirectly (for example, through networked means). In an example, the engine(s) 104 may include a processing resource, for example, either a single processor or a combination of multiple processors, to execute such instructions. In other examples, the engine(s) 110 may be implemented as electronic circuitry. The engine(s) 104 includes a data processing engine 106 and a flight parameter generation engine 108.

In operation, in case of a connected flight management system, the pilot may push-in flight plans or changes to the connected flight management system, such as using an audio input as the input data. In an example, the input data may be a text input. The input data is associated with a flight assistance parameter of an aircraft such as real-time weather information which may be obtained from a network. In an example, the pilot may receive the data from an Electronic Flight Bag (EFB) and further can be used as the input data. The EFB may be an external management device, such as a portable electronic device, to assist flight crews in flight management.

Initially, the data processing engine 106 of the system 100 may obtain the input data from a user directly or from the user via the EFB. In an example, the input data may be received from a pilot. In an example, the user may be pilot of the aircraft. In an example, the user may a crew member of the aircraft. In an example, the user may an operator sitting at an air traffic control unit. In an example, the input data can be an audio input. In an example, the input data can be a text input. In an example, the input data may be received from an EFB. For example, in case of a connected flight management system, the pilot may push-in flight plans or changes to the connected flight management system, such as using an audio input as the input data. The input data is associated with a flight assistance parameter of an aircraft such as real-time weather information which may be obtained from a network. The flight assistance parameter assists in optimizing the flight plan of the aircraft. In an example, the input data may be referring to change of landing airport, for example, from New York to New Jersy. In an example, the input data may be updated weather details at different time periods.

Upon obtaining the input data, the data processing engine 106 processes the obtained input data at each of a predetermined number of flight plan applications. In an example, the flight plan applications are EFB applications. It is ensured that at least one flight plan application, from among the predetermined number of flight plan applications, is heterogeneous with respect to other flight plan applications. In an example, all the flight plan applications may be heterogeneous. The heterogenous processing of the input data increases the trust level that avionics can place on the data sourced from flight plan applications, i.e., EFB applications. The heterogenous processing obviates the disadvantages of common path processing of the input data. Each flight plan application independently processes the input data, and output data is obtained from each of the flight plan applications. Therefore, the output data obtained from each of the flight plan applications can be checked to ensure the authenticity of the output data.

Before transmitting the processed data, i.e., output data to the avionics, the output data is checked to confirm the authenticity of the output data so that the avionics can be prevented from receiving any corrupted data. The corrupted data may include a malicious program, a virus, modified data, and/or any suspicious data. Examples of suspicious data may include a file having a file size different than that of predetermined file size. Thus, the data processing engine 106 determines a confidence level of the output data for checking the output data authenticity. Such a determination may be made depending on a degree of agreement between the output data. The confidence level is associated with a data acceptability level. The degree of agreement is an indicative of similarity in the output data from different sources. The higher is the confidence level, the higher is the data acceptability level and lower is the chance that the output data is corrupted or compromised. In an example, the degree of agreement is directly proportional to the confidence level. On the other hand, the lower confidence level is an indicative that the output data that may include a malicious program, modified data, etc., which on execution may cause irregularity in the functioning of the avionics, i.e. flight management system.

If the data processing engine 106 determines that the output data have the confidence level in a prespecified threshold, the flight parameter generation engine 108 further calculates flight modification parameters using the processed output data. In an example, if the output data from all sources, i.e., all the flight plan applications agree with each other with a confidence level of 100%, the output data is accepted for further processing. The flight modification parameters are transmitted by the flight parameter generation engine 108 to the flight management system of the aircraft for continuing optimal flight operation of the aircraft. In an example, the flight modification parameters may comprise at least one of an increase in speed, a decrease in speed, an increase in altitude, a decrease in altitude, and a change in flight route of the aerial vehicle. The flight management system is at least one of an onboard flight management system located onboard the aircraft or a remote flight management system located remotely from the aircraft, and the flight modification parameters are received from at least one of the onboard flight management system onboard or the remote flight management system.

Upon determining by the data processing engine 106 that the output data have the confidence level below the prespecified threshold, the data processing engine 106 may stop further transmission of the output data.

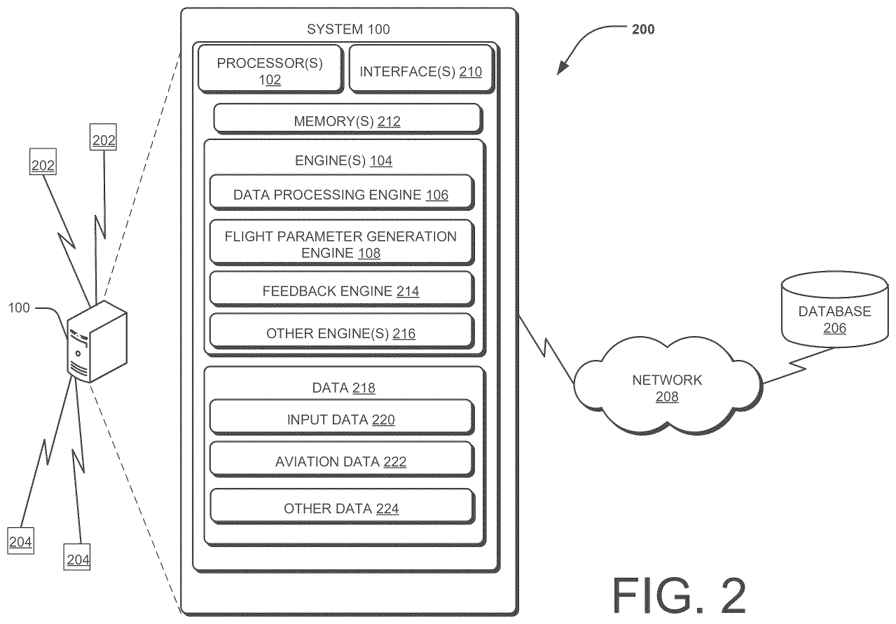

FIG. 2 illustrates a network environment 200 for managing security of input data received to be used with avionics, according to an example. The network environment 200 includes the system 100 for managing security of input data received to be used with avionics 202, in the aerial vehicle (not shown in FIG. 2). The system 100 is described in FIG. 1 and may include, but is not limited to, a laptop, a notebook computer, a server computer, a tablet computer. In an example, the input data may be received from an EFB 204. The input data may be processed in the EFB applications residing in the EFB 204. The EFB may be an external management device, such as a portable electronic device, to assist flight crews in flight management. The avionics da202 are electronics used in aviation and are installed in the aerial vehicles. The avionics 202 may include, but is not limited to, flight management systems, engine controls, flight control systems, navigation, communications, flight recorders, lighting systems, threat detection, fuel systems, electro-optic systems, weather radar, etc. The system 100 may connect with the plurality of EFBs 204 and multiple avionics 202. The system 100 may include the processor(s) 102 similar to depicted in FIG. 1. Further, in an example, the system 100 may be connected to a database 206 through a network 208. The database 206 may be, for example, a structured query language (SQL) data store or a not only SQL (NoSQL) data store. In an exemplary implementation, the database 206 may be configured as cloud-based database implemented in the aviation environment. In another exemplary implementation, the database 206 may be a location on a file system directly accessible by the engines. The database 206 may be configured to store data of the EFB applications and data of the avionics engineering project files, program files, object behavior model, parameter values associated with the flight plan and the like.

The network 208 may be a wireless network, a wired network, or a combination thereof. The network 208 can also be an individual network or a collection of many such individual networks, interconnected with each other and functioning as a single large network, e.g., the Internet or an intranet. The network 208 can be implemented as one of the different types of networks, such as intranet, local area network (LAN), wide area network (WAN), the internet, and such. The network 208 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other.

In one implementation, the network environment 200 may be an aviation network, including personal computers, laptops, various servers, such as blade servers, and other computing devices connected over the network 208. The system 100 includes the processor(s) 102. Further, the system 100 includes interface(s) 210 and memory(s) 212. The interface(s) 210 may allow the connection or coupling of the system 100 with one or more other devices, through a wired (e.g., Local Area Network, i.e., LAN) connection or through a wireless connection (e.g., Bluetooth®, Wi-Fi). The interface(s) 210 may also enable intercommunication between different logical as well as hardware components of the system 100.

The memory(s) 212 may be a computer-readable medium, examples of which include volatile memory (e.g., RAM), and/or non-volatile memory (e.g., Erasable Programmable read-only memory, i.e., EPROM, flash memory, etc.). The memory(s) 212 may be an external memory, or internal memory, such as a flash drive, a compact disk drive, an external hard disk drive, or the like. The memory(s) 212 may further include data which either may be utilized or generated during the operation of the system 100.

The engine(s) 104 of the system 100 may further include a feedback engine 214 and other engines 216 in addition to the data processing engine 106 and the flight parameter generation engine 108 as depicted in FIG. 1. The feedback engine 214 and the other engine(s) 216 may be implemented as a combination of hardware and programming, for example, programmable instructions to implement a variety of functionalities of the engine(s). In examples described herein, such combinations of hardware and programming may be implemented in several different ways. For example, the programming for the engine(s) may be executable instructions. Such instructions may be stored on a non-transitory machine-readable storage medium which may be coupled either directly with the system 100 or indirectly (for example, through networked means). In an example, the engine(s) may include a processing resource, for example, either a single processor or a combination of multiple processors, to execute such instructions. In other examples, the engine(s) may be implemented as electronic circuitry. The system 100 may further include data 218.

Each of the plurality of EFBs 204 may include one or more EFB applications. In an example, one of the one or more EFB applications may be a weather application that provides real-time details such as weather details, wind profile etc. In another example, one of the one or more EFB applications may be a documentation application that provides details such as aircraft configuration, gear system information, instrument flight rules (IFR) plan, navigation maps etc. The one or more EFB applications may be included in a portable electronic device such as a laptop or tablet which may be connected to a network. The data of the one more EFB applications, in an example, used as an input data 220, may be from an open-source environment. Such open-source data may get affected by a malicious program, modified data, etc., before it reaches the avionics 202. The affected input data on execution may cause irregularity in the functioning of the avionics and is therefore not a valid data. The data of the one or more avionics 202 is authentic. The data obtained from the one or more avionics 202 are hereinafter referred to as aviation data 222. The system 100 manages the security of input data to be used with the avionics 202. In another example, the one or more EFB applications may include other data 224 such as flight crew operating manuals, etc.

The system environment 200 is in operation once the input data 220 is received. In an example, the system environment 200 is in operation once the EFBs 204 are connected to the system 100 to provide the input data 220. The EFB applications of the plurality of the EFBs 204 have data relevant to the avionics 202 and such data may be received by the data processing engine 106 of the system 100. In an example, the plurality of EFBs 204 may connect to system 100 wired or wirelessly depending on the environment requirements.

Initially, when the pilot push-in flight plans or changes to the connected flight management system, such as using an audio input as the input data or the EFB push-in flight plans or changes, the data processing engine 106 of the system 100 may obtain the input data 220. The input data may be associated with at least one of flight assistance parameters of the aircraft. For example, the input data may be an indicative of change in flight altitude because of real-time weather conditions. In an example, the input data may be received from a pilot as a voice input, where the pilot may have received information from the air traffic control. In an example, the input data may be received from a pilot as a text input, where the pilot may have received information from the air traffic control. In an example, the EFB 204 may issue the input data based on the real-time data available to the EFB 204. In all the scenarios, the input data 220 is further conveyed to the avionics 202, i.e., flight management system to implement the required changes in the flight plan based on the input data 220. To ensure the safety of the aircraft, the input data 220 is processed such that the input data 220 is only conveyed to the avionics 202 if it is uncompromised. This is done because, the input data 220 may be compromised before it reaches to the avionics 202, for example, due to a cyber-attack. The compromised input data 220 may include a malicious program, a virus, modified data, and/or any suspicious data. The compromised input data 220 may be harmful for the aircraft. In an example, the data processing engine 106 may include a set of translator applications. In an example, the translator applications may be heterogeneous. The translator application is to translate the input data 220 to a format processable by respective flight plan applications. Each flight plan application accepts input data in a specific format. Therefore, the translator applications help the flight plan applications to get the input data in a desired format.

Upon obtaining the input data 220, the data processing engine 106 may process the obtained input data at each of a predetermined number of flight plan applications. In an example, the flight plan applications are EFB applications. It is ensured that at least one flight plan application, from among the predetermined number of flight plan applications, is heterogeneous with respect to other flight plan applications. In an example, all the flight plan applications may be heterogeneous. The heterogenous processing of the input data increases the trust level that avionics can place on the data sourced from flight plan applications, i.e., EFB applications. The heterogenous processing obviates the disadvantages of common path processing of the input data. Each flight plan application independently processes the input data, and output data is obtained from each of the flight plan applications. Therefore, the output data obtained from each of the flight plan applications can be checked to ensure the authenticity of the output data. If the input data is processed through different flight plan applications, then the output data from each of the different flight plan applications is a reliable variable to check the authenticity.

Before transmitting the processed data, i.e., output data to the avionics, the output data is checked to confirm the authenticity of the output data so that the avionics can be prevented from receiving any corrupted data. The corrupted data may include a malicious program, a virus, modified data, and/or any suspicious data. In order to do so, the data processing engine 106 determines a confidence level of the output data for checking the output data authenticity. In an example, such a determination may be made depending on a degree of agreement between the output data. In an example, such a determination may be made depending on a degree of disagreement between the output data. The confidence level is associated with a data acceptability level. The degree of agreement is an indicative of similarity in the output data from different sources. The higher is the confidence level, the higher is the data acceptability level and lower is the chance that the output data is corrupted or compromised. In an example, the degree of agreement is directly proportional to the confidence level. The degree of disagreement is an indicative of dissimilarity in the output data from different sources. The lower is the confidence level, the lower is the data acceptability level and higher is the chance that the output data is corrupted or compromised. The lower confidence level, i.e., higher degree of disagreement is an indicative that the output data that may include a malicious program, modified data, etc., which on execution may cause irregularity in the functioning of the avionics, i.e. flight management system. For determining the confidence level of the output data, a number of similar output data P_{AGREE} from the flight plan applications is determined. For example, if the input data 220 is processed through 4 flight plan applications and 3 flight plan applications have the same output data, then the number of similar output data is 3 in such a case. Further, a total number of output data P_{TOTAL} received from the flight plan applications is determined. For example, if the input data 220 is processed through 4 flight plan applications, then the total of output data is 4 in such a case. Further, the confidence level is computed in percentage by dividing the number of similar output data with the total number of output data and further multiplying by hundred, i.e., confidence level (percentage acceptance)=(P_{AGREE}/P_{TOTAL})*100. For example, if the input data 220 is processed through 4 flight plan applications and 3 flight plan applications have the same output data, then the number of similar output data is 3 and the total of output data is 4. The confidence level is computed as 3 divided by 4 and then multiplied by 100, i.e., the confidence level is 75%.

After determining the confidence level, the data processing engine 106 may compare the determined confidence level with a prespecified threshold. The prespecified threshold may be set depending on the safety criticality. For example, for some less critical parameters, the prespecified threshold may be 80%. While for the critical parameters, the prespecified threshold may be 90% and may be 100% for extremely critical parameters. In an example, the confidence level may be determined depending on a degree of disagreement between the output data. The confidence level is an indicative of a data acceptability level. The more is the degree of disagreement, the less is the confidence level and the less will be the data acceptability level. On determining based on the comparison that the determined confidence level is below the prespecified threshold, the output data is rejected, i.e., the avionics 202 does not accept the input data 220 for updates in the flight plan.

The prespecified threshold for confidence level could be adjustable based on various factors such as flight phase, weather conditions, or airspace complexity. For example, during critical flight phases like take-off or landing, the system 100 could require a higher confidence level threshold before accepting output data. Conversely, during cruise phase in clear weather conditions, a lower threshold might be acceptable. In an example, instead of using fixed prespecified thresholds, the system 100 may implement adaptive thresholds that dynamically adjust based on historical performance, current flight conditions, and the criticality of the decision being made. This would allow for more flexible and context-aware decision-making.

On determining based on the comparison that the determined confidence level is within the prespecified threshold, the flight parameter generation engine 108 may accept the output data for calculating flight modification parameters using the output data. In an example, the flight modification parameters may comprise at least one of an increase in speed, a decrease in speed, an increase in altitude, a decrease in altitude, and a change in flight route of the aerial vehicle.

In an example, for the output data determined to have the confidence level of 100%, the flight parameter generation engine 108 may calculate flight modification parameters using the output data. The confidence level of 100% indicates that the degree of disagreement is negligible and therefore the output data is not compromised.

In case the output data is determined to have the confidence level with a first prespecified value indicating that the degree of disagreement is present. That is, at least one output data of one flight plan application is different from the output data of the other flight plan applications. The output data is authenticated to check if it can still be used with the avionics 202. In an example, the output data indicating the degree of disagreement may be authenticated by checking nearby waypoints, such as fuel, altitude, etc. The nearby waypoint is an indicator associated with a flight plan summary. The flight plan summary may include, but is not limited to, fuel, distance, travel route, and travel time. On determining that the output data is authentic, the flight parameter generation engine 108 may calculate flight modification parameters using the output data. In an example, prior to rejecting the output data on determining the confidence level below the prespecified threshold, the data processing engine 106 may verify the nearby waypoint to the output data to authenticate context sensitivity of the output data. For example, if the output data is related to distance shortening then fuel parameter may be checked to authenticate context sensitivity of the output data. In an example, if the data processing engine 106 determines that the output data at each of the flight plan applications is different, the output data may be rejected without any further authentication. In an example, the feedback engine 214 may rate the flight plan applications as unreliable based on the output data. The nearby waypoint-based check or statistical means are triggered only when there is a degree of disagreement. The generic indicators are flight plan summary like distance, fuel, time etc. and such indicators are kept configurable.

In an example, the system 100 may incorporate more sophisticated feedback mechanisms to continuously improve the weightage of each flight plan application. This could include machine learning algorithms that analyse patterns in the accuracy of each flight plan application over time, considering factors such as flight conditions, routes, and aircraft type. The system 100 may then dynamically adjust the weightage of each application in real-time based on these learned patterns.

As an example implementation of having 3 flight plan applications to process the same input data, if two paths, i.e., flight plan applications are telling KPHX (66%) but one is telling KLAX (33%), then the nearby waypoint is checked with insights and if found suitable to the context, such as fuel, distance to confirm if it is KPHX and if so, KPHX is finalized. If the disagreement degree is higher (confidence level lower than 50%), then the data is rejected. For example, one is telling KPHX (33%), the other KLAX (33%), while the third one indicates KSFO (33%), then the data rejected. In case of a remote chance of all output data getting corrupted with same (KSFO by all 3 flight plan applications), the context sensitivity based on statistical means can be assessed for the pilot review prompt.

In addition to verifying nearby waypoints, the data processing engine 106 may employ other approaches to authenticate the context sensitivity of output data. These could include cross-referencing with historical flight data, comparing with real-time data from other aircraft in the vicinity, or validating against ground-based navigation systems. This multi-faceted approach to data authentication could further enhance the system's 100 ability to detect and prevent the use of compromised or erroneous data.

If the data processing engine 106 determines that the output data have the confidence level in the prespecified threshold, the flight parameter generation engine 108 further calculates flight modification parameters using the processed output data. In an example, if the output data from all sources, i.e., all the flight plan applications agree with each other with a confidence level of 100%, the output data is accepted for further processing. The confidence level of 100% indicates that the output data from each of the flight plan applications are the same.

If the data processing engine 106 determines that the output data have the confidence level in a prespecified threshold, the flight parameter generation engine 108 further calculates flight modification parameters using the processed output data. In an example, if the output data from all sources, i.e., all the flight plan applications agree with each other with a confidence level of 100%, the output data is accepted for further processing. The flight modification parameters are transmitted by the flight parameter generation engine 108 to the flight management system of the aircraft for continuing optimal flight operation of the aircraft. In an example, the flight modification parameters may comprise at least one of an increase in speed, a decrease in speed, an increase in altitude, a decrease in altitude, and a change in flight route of the aerial vehicle. The flight management system is at least one of an onboard flight management system located onboard the aircraft or a remote flight management system located remotely from the aircraft, and the flight modification parameters are received from at least one of the onboard flight management system onboard or the remote flight management system.

In an example, the flight modification parameters may be calculated using the output data if the output data from each of the flight plan applications are the same, i.e., have similar values at each of the flight plan applications.

In an example, the data processing engine 106 may initiate a pilot review prompt to authenticate context sensitivity of the output data when the output data determined to have similar values at each of the flight plan applications. For example, for an input X if an output Y is expected but at each of the flight plan applications, an output Z is obtained. In such a scenario where the confidence level of 100% is determined but statistically the output Z is not feasible, the pilot review prompt is initiated so that the pilot can check the context sensitivity of the output data.

In an example, the feedback engine 214 may determine the output data having the confidence level in the prespecified threshold as graded data. Further, the graded data may be transmitted to each of the flight plan applications and further ascertaining if the graded data is an actual output corresponding to the input data received for the processing at each of the flight plan applications. Upon ascertaining that the graded data is the actual output, the feedback engine 214 This is done to verify if the output data is the actual output for the input data. In case of any deviations, the feedback engine 214 tag the graded data as invalid.

Further, the feedback engine 214 may issue feedback for the flight plan applications so that a preset judgement may be applied to output data received from said flight plan applications. In an example, the feedback engine 214 may obtain feedback for each of the flight plan applications based on computation of the output data at each of the flight plan applications. Accordingly, the feedback engine 214 updates weightage of each of the flight plan applications based on the feedback. For example, a flight plan application outputting an output data for an input data with 100% accuracy may be assigned with a higher weightage as compared to another flight plan application with lower accuracy. The data processing engine 106 may determine the confidence level of the output data depending on the degree of agreement between the output data and the updated weightage of each of the flight plan applications for a more optimized result.

In an example, other engines 216 may perform a validation test on the acceptable output data to determine if the output data is compromised, i.e., includes a malicious program, a virus, modified data, and/or any suspicious data. Examples of suspicious data may include a file having a file size different than that of predetermined file size. In an example, the validity test may be a startup test. The validation test may be based on a validation setting being one of a manual validation setting and an auto validation setting. When the validation setting is manual validation setting, the data processing engine 106 performs the validity test on receiving a prompt from the pilot. When the validation setting is auto validation setting, the data processing engine 106 performs the validity test automatically upon receiving the input data during or before a flight operation of the aerial vehicle.

Upon determining that the output data is unfit for further use, i.e., the output data is compromised, i.e., the flight plan application having compromised data is also determined to be compromised. Further, the data processing engine 106 of the system 100 may apply an isolation and neutralization technique on the one or more flight plan applications whose output data are compromised to restrict said one or more flight plan applications. For example, the flight plan application may be a weather forecast application that may contain a virus. Upon determination of the output data obtained from the weather forecast application to be compromised, the data processing engine 106 may stop the working of the weather forecast application to restrict the receiving of the data from the weather forecast application. In another example, the data processing engine 106 may restrict the receiving of the compromised data by blocking connection, such as, by blocking IP address of the device associated with the flight plan application containing the compromised data. In yet another example, the data processing engine 106 may delete the data received from the device, i.e., EFB 204 associated with the flight plan application containing the compromised data. In another example, the data processing engine 106 may provide a notification to the pilot and request the pilot to provide an input for performing certain operations, such as, deletion of compromised data, blocking on receiving data. The data which are determined not to be compromised are further used along with avionic data received from the one or more avionics.

Further, the flight parameter generation engine 108 calculates flight modification parameters based on the output data which are determined not to be compromised, i.e., have the confidence level within the prespecified threshold. In some examples, the flight parameter generation engine 108 calculates flight modification parameters based on the output data and the certified avionic data received from the one or more avionics 202. The flight modification parameters optimize the operation and management of the aerial vehicle. For example, the flight parameter generation engine 108 may calculate flight modification parameters based on real-time weather data, i.e., output data. Based on the real-time weather data and the certified avionic data received from the one or more avionics 202, such as flight management system (FMS), flight modification parameters are calculated to optimize the operation and management of the aerial vehicle. In an example, the flight modification parameters may comprise at least one of an increase in speed, a decrease in speed, an increase in altitude, a decrease in altitude, and a change in flight route of the aerial vehicle. The flight parameter generation engine 108 may transmit the flight modification parameters to the FMS of the aerial vehicle.

The system 100 could utilize different types of flight plan applications including specialized applications for route optimization, fuel efficiency calculation, weather pattern analysis, or air traffic congestion prediction. By incorporating a diverse range of application types, the system 100 could enhance its ability to cross-validate input data and increase the robustness of its confidence level determinations.

Instead of simply accepting or rejecting output data based on the confidence level, the system 100 may implement a weighted averaging approach. In this variation, output data from different flight plan applications could be combined using weights based on their historical accuracy or reliability. This could allow for more nuanced decision-making when the confidence level falls within a certain range.

The system 100 may incorporate advanced cybersecurity features to protect against potential threats to the integrity of the input and output data. This could include encryption of data transmissions, secure authentication protocols for flight plan applications, and real-time monitoring for anomalous behavior or potential cyber-attacks.

By analysing historical data and patterns, the system 100 may incorporate predictive analytics to anticipate potential issues or optimize flight parameters proactively. This could include predicting areas of turbulence, forecasting fuel consumption, or suggesting optimal routes based on learned patterns.

While the system 100 aims to reduce the need for manual pilot review, it could incorporate intelligent prompts or alerts that bring specific issues to the pilot's attention when human judgment is deemed necessary. This would create a more collaborative approach between the automated system and human expertise. These additional variations and enhancements would further strengthen the system's ability to manage the security of input data, improve the accuracy and reliability of flight modification parameters, and ultimately enhance the safety and efficiency of aircraft operations.

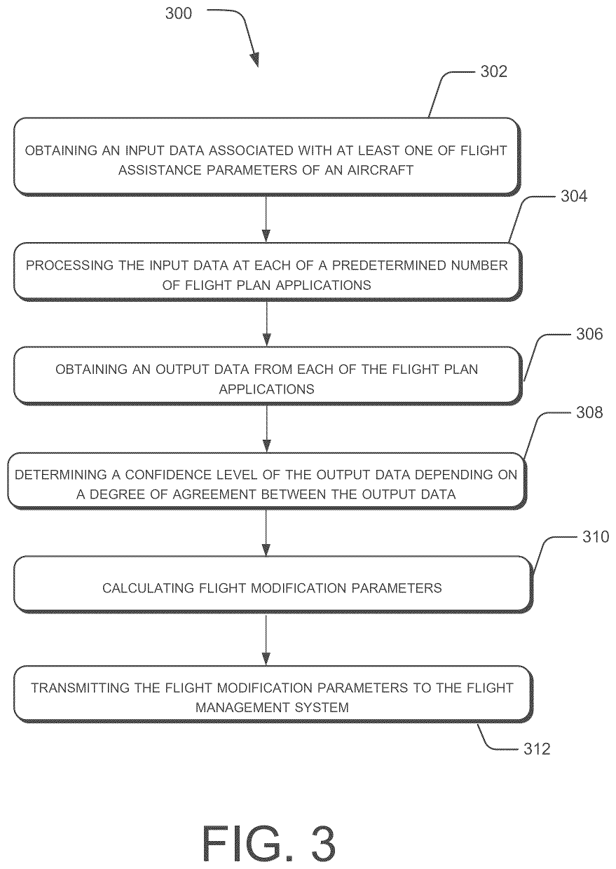

FIG. 3 illustrates a method 300 for managing security of data to be used with avionics, according to an example. The order in which the above-mentioned methods are described is not intended to be construed as a limitation, and some of the described method blocks may be combined in a different order to implement the method, or an alternative method.

Furthermore, the above-mentioned method may be implemented in a suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encode computer-executable instructions, where the instructions perform some or all the steps of the above-mentioned method.

Referring to FIG. 3, the method 300 may be implemented by a system for managing security of data to be used with avionics. The system may be similar to the system of FIG. 1.

At block 302, the method includes obtaining an input data associated with at least one of flight assistance parameters of an aircraft. Such input data is obtained when the pilot push-in flight plans or changes to the connected flight management system, such as using an audio input as the input data or the EFB push-in flight plans or changes, such as change in flight altitude because of real-time weather conditions. The input data may be received from a pilot as a voice input or as a text input. The pilot may have received information from the air traffic control or from any EFB connected to the flight management system. The input data is further conveyed to the avionics, i.e., flight management system to implement the required changes in the flight plan based on the input data. To ensure the safety of the aircraft, the input data is processed such that the input data is only conveyed to the avionics if it is uncompromised. The compromised input data may be harmful for the aircraft. In an example, input data may be a real-time weather data or a real-time planning data, which may be utilized by avionics of the aircraft to modify flight operation, such as adapting to an optimized flight route. In an example, the flight modification parameters include, but are not limited to, an increase in speed, a decrease in speed, an increase in altitude, a decrease in altitude, and a change in flight route. For example, considering a scenario where a passenger aircraft is scheduled to take-off and pilot of the passenger aircraft may have access to a portable device, i.e., an EFB. The portable device is connected to the internet, i.e., open source and may have versatile data in various EFB applications that may be useful for flight operations. Such data may be an input data received by the system 100.

At block 304, the method includes processing the input data at each of a predetermined number of flight plan applications. In an example, the flight plan applications are EFB applications. It is ensured that at least one flight plan application, from among the predetermined number of flight plan applications, is heterogeneous with respect to other flight plan applications. In an example, all the flight plan applications may be heterogeneous. The heterogenous processing of the input data increases the trust level that avionics can place on the data sourced from flight plan applications, i.e., EFB applications. The heterogenous processing obviates the disadvantages of common path processing of the input data. The heterogenous graded inputs from the flight plan applications aim to provide more than one path for the same input data and cross validating the data received from multi-source and multi-path for increasing the overall integrity of the data. In an example, each heterogeneous flight plan application independently processes the input data

Further, at block 306, the method 300 includes obtaining an output data from each of the flight plan applications. The obtained output data can be checked to ensure the authenticity of the output data. If the input data is processed through different flight plan applications, then the output data from each of the different flight plan applications is a reliable variable to check the authenticity. The check is to prevent the avionics from receiving any corrupted data. The corrupted data may include a malicious program, a virus, modified data, and/or any suspicious data and usage of such corrupted data may be fatal for the aircraft.

At block 308, the method 300 includes determining a confidence level of the output data depending on a degree of agreement between the output data. The confidence level of the output data is determined before transmitting the processed data, i.e., output data to the avionics so that the avionics can be prevented from receiving any corrupted data. In an alternate example, such a determination may be made depending on a degree of disagreement between the output data. The confidence level is associated with a data acceptability level. The degree of agreement is an indicative of similarity in the output data from different sources. The higher confidence level amounts to higher data acceptability level and lower chance of output data corruption. In an example, the degree of agreement is directly proportional to the confidence level. On the contrary, the degree of disagreement is an indicative of dissimilarity in the output data from different sources. The lower confidence level, i.e., higher degree of disagreement is an indicative that the output data that may include a malicious program, modified data, etc., which on execution may cause irregularity in the functioning of the flight management system.

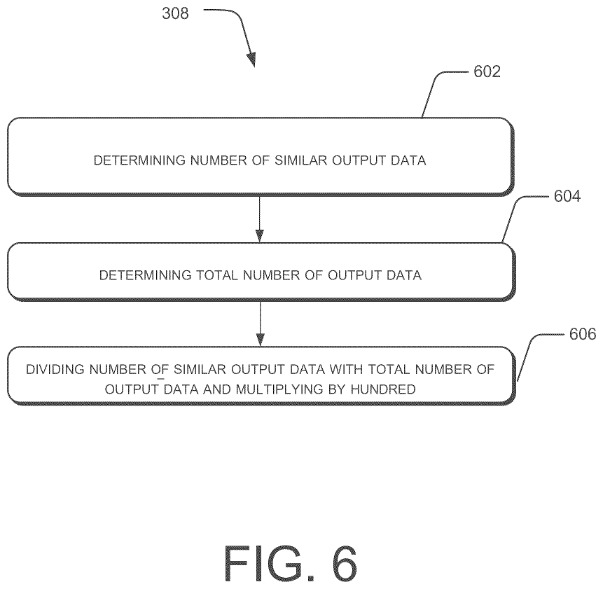

The determining of the confidence level of the output data is depicted in FIG. 6. In FIG. 6, at block 602, a number of similar output data P_{AGREE} from the flight plan applications is determined. For example, if the input data is processed through 5 flight plan applications and 4 flight plan applications have the same output data, then the number of similar output data is 4 in such a case.

Further at block 604, a total number of output data P_{TOTAL} received from the flight plan applications is determined. For example, if the input data is processed through 5 flight plan applications, then the total of output data is 5 in such a case.

Further, at block 606, the confidence level is computed in percentage by dividing the number of similar output data with the total number of output data and further multiplying by hundred, i.e., confidence level (percentage acceptance)=(P_{AGREE}/P_{TOTAL})*100. For example, if the input data is processed through 5 flight plan applications and 4 flight plan applications have the same output data, then the number of similar output data is 4 and the total of output data is 5. The confidence level is computed as 4 divided by 5 and then multiplied by 100, i.e., the confidence level is 80%.

Returning to block 308 of FIG. 3, after determining the confidence level, the determined confidence level may be compared with a prespecified threshold. The prespecified threshold may be set depending on the safety criticality. For example, for some less critical parameters, the prespecified threshold may be in range of 80-90%. While for the critical parameters, the prespecified threshold may be more than 90% and may be 100% for extremely critical parameters. The prespecified threshold for confidence level could be adjustable based on various factors such as flight phase, weather conditions, or airspace complexity. For example, during critical flight phases like take-off or landing, the system 100 could require a higher confidence level threshold before accepting output data. Conversely, during cruise phase in clear weather conditions, a lower threshold might be acceptable.

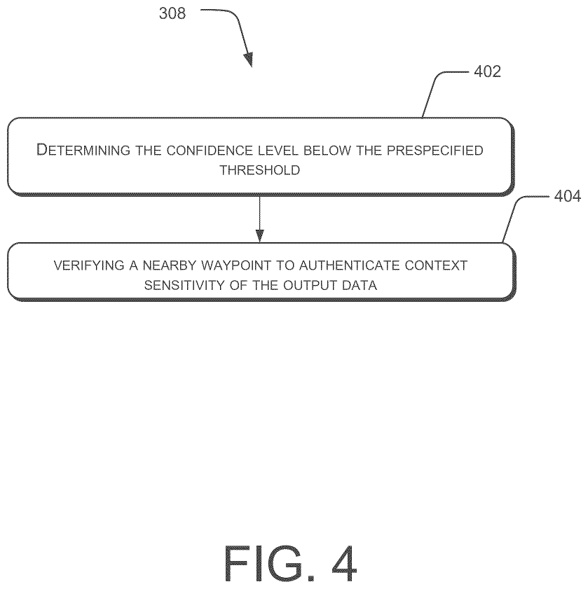

A scenario where the confidence level is below the prespecified threshold is depicted in FIG. 4. In FIG. 4, at block 402, the confidence level is determined to be below the prespecified threshold.

At block 404, when the output data is determined to have the confidence level indicating that the degree of disagreement is present. That is, at least one output data of one flight plan application is different from the output data of the other flight plan applications. A nearby waypoint to the output data is verified to authenticate context sensitivity of the output data. The nearby waypoint is an indicator associated with a flight plan summary.

The nearby waypoint is checked so that output data can be authenticated to check if it can still be used with the avionics. In an example, the output data indicating the degree of disagreement may be authenticated by checking nearby waypoints, such as fuel, altitude, etc. The flight plan summary may include, but is not limited to, fuel, distance, travel route, and travel time. For example, if the output data is related to distance shortening then fuel parameter may be checked to authenticate context sensitivity of the output data. On determining that the output data is authentic or on determining that the confidence level of the output data is within the prespecified threshold, the method 300 includes calculating flight modification parameters using the output data as depicted in block 310 of FIG. 3.

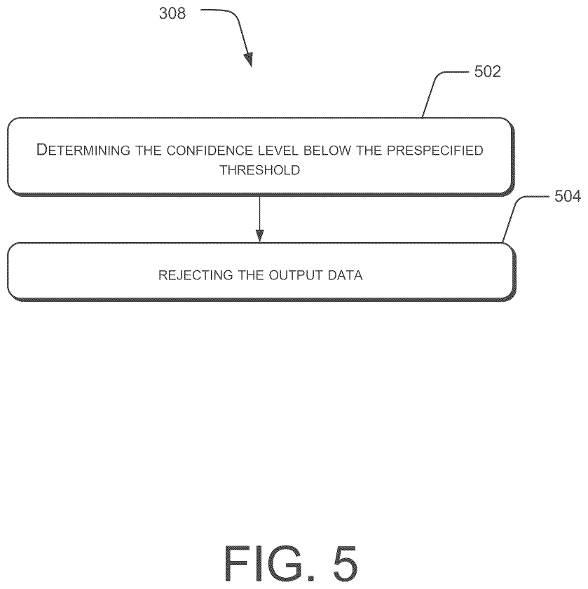

Another scenario where the confidence level is determined to be below the prespecified threshold is depicted in FIG. 5. In FIG. 5, at block 502 the confidence level is determined to be below the prespecified threshold. Further, at block 504, the output data is rejected on such a determination, i.e., the avionics does not accept the output data for updates in the flight plan. In an example, prior to rejecting the output data on determining the confidence level below the prespecified threshold, the nearby waypoint to the output data may be verified to authenticate context sensitivity of the output data. For example, if the output data is related to distance shortening then fuel parameter may be checked to authenticate context sensitivity of the output data. In an example, if the output data at each of the flight plan applications is different, the output data may be rejected without any further authentication.

Returning to block 310 of FIG. 3 where the flight modification parameters are calculated using the processed and acceptable output data. In an example, if the output data from all sources, i.e., all the flight plan applications agree with each other with a confidence level of 100%, the output data is accepted for further processing. The confidence level of 100% indicates that the output data from each of the flight plan applications are the same. In such a case, the flight modification parameters are calculated using the acceptable output data without any comparison with the prespecified threshold. In an example, when the output data from each of the flight plan applications are the same, a pilot review may be initiated. The flight modification parameters are calculated so that the operation and management of the aerial vehicle can be optimized. For example, a real-time navigational chart may help in optimizing the flight route of the aerial vehicle, on ascertaining that the real-time navigational chart is received from a safe flight plan application, the same may be used along the aviation data, for example, already present coordinates of the flight route for calculating a modified flight route.

At block 312, the method 300 includes transmitting flight modification parameters to the flight management system of the aircraft for continuing optimal flight operation of the aircraft. In an example, the flight modification parameters may comprise at least one of an increase in speed, a decrease in speed, an increase in altitude, a decrease in altitude, and a change in flight route of the aerial vehicle. The flight management system is at least one of an onboard flight management system located onboard the aircraft or a remote flight management system located remotely from the aircraft, and the flight modification parameters are received from at least one of the onboard flight management system onboard or the remote flight management system. In an example, the modified flight route, i.e., the flight modification parameter may be transmitted to the avionics, i.e., the flight management system either automatically or when prompted by the pilot of the aerial vehicle. After the transmission, the flight management system of the aerial vehicle may utilize the flight modification parameter for further operation of the aerial vehicle.

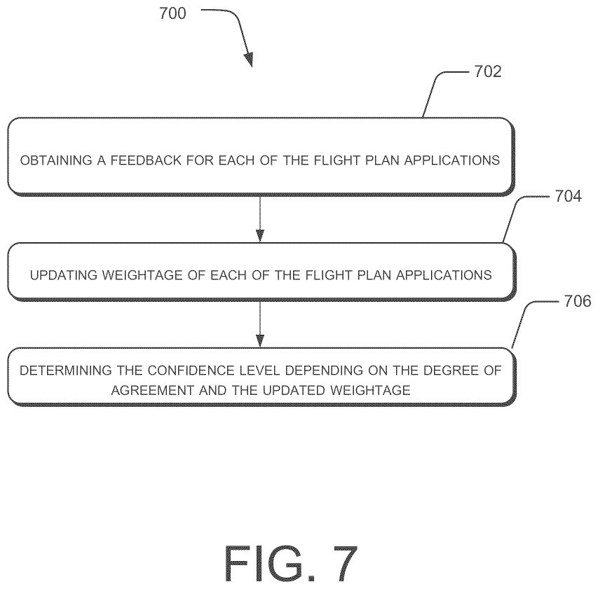

FIG. 7 illustrates a feedback generation method 700 for the output data obtained from different flight plan applications. At block 702, the method 700 includes obtaining feedback for each of the flight plan applications. The feedback is to set a preset consideration to output data received from said flight plan applications. In an example, the feedback for each of the flight plan applications may be obtained based on computation of the output data at each of the flight plan applications.

At block 704, the method 700 includes updating weightage of each of the flight plan applications. The weightage is updated based on the feedback. For example, a flight plan application outputting an output data for an input data with 100% accuracy may be assigned with a higher weightage as compared to another flight plan application with lower accuracy. Further, at block 706, the method 700 includes determining the confidence level of the output data depending on the degree of agreement between the output data and the updated weightage of each of the flight plan applications for a more optimized result. In an example, based on the feedback, the flight plan applications may be rated as unreliable based on the output data. like distance, fuel, time etc. and such indicators are kept configurable. In an example, based on the feedback, a validity test may be performed to further authenticate the validity of the output data. The output data is based on the input data, which may be from an open source and thus not authenticated. Such open-source data is prone to contamination due to cyber threats, such as a malicious program, a virus, modified data, and/or any suspicious data. This contaminated data may badly affect the flight operations if used directly without any prior check. In an example, in the validity check, the size of the file of the output data may be compared with a predetermined range of file size. For example, from a particular flight plan application, such as weather update application, size of the file is commonly of 4 to 6 Megabytes, so the predetermined range of file size for this particular flight plan application may be 4 to 6 Megabytes. For example, on comparison, if the file size is determined to be within the predetermined range of file size, the file is determined to be safe and can be used with the flight management system. Based on the comparison, the flight plan application and its output data may be determined to be compromised upon determining that the size of the file is not within the predetermined range of file size. In an example, if the file size if either 3 Megabytes or 7 Megabytes, the size of the file is not within the predetermined range of file size and therefore the flight plan application and its output data may be marked as compromised and either termination of the compromised flight plan application may be planned or only its output data is rejected and the flight plan application undergo further authentication checks. In an example, the validity test may be an interactive test, where the pilot of the aircraft may provide an input to initiate the validity test to determine if the output data is compromised. In an example, the setting of the validity test may be defined from one of a manual validation setting and an auto validation setting. In the manual validation setting, the validity test may be performed on receiving a prompt from the user. In the auto validation setting, the validity test may be performed automatically during a startup of a flight operation of the aerial vehicle. In an example, the user may be the crew member seated at a backend office of service provider of an airline managing the aerial vehicle.

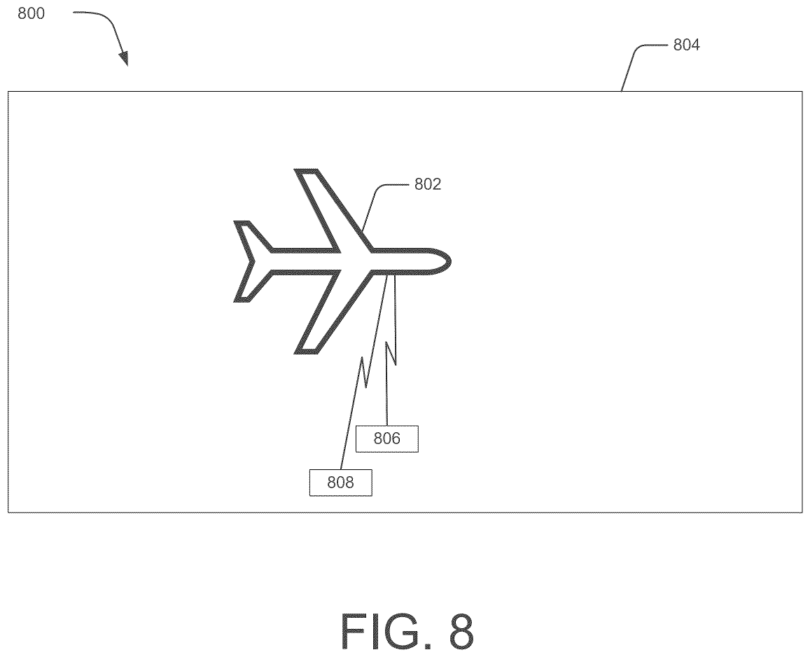

FIG. 8 depicts an environment 800 where an aircraft 802 is at a runway 804 before takeoff, according to an example. Firstly, in this environment 800, in an example, a system (now shown here) which is similar to the system 100 may begin with receiving from a flight management system 806 disposed onboard of the aircraft, real-time flight data. The real-time flight data may comprise at least one of the predicted fuel available in the aircraft when the aircraft lands, the predicted weight of the aircraft when the aircraft lands, any jettison or anomalous fuel quantity which would affect the predicted fuel level and the weight of the aircraft, the fuel flow data between the left and right pumps as desired by the crew, the predicted estimated time of arrival (ETA) of the aircraft at a stopover airport, any unplanned diversion from original flight path by the crew due to weather, traffic or other issues, and any minimum equipment list (MEL) constraints developed by the enroute aircraft. The real-time flight data is certified data.

Further, the system may then obtain an input data from the pilot of the aircraft via third party data sources 808, real-time weather and/or traffic data for the flight path of the aircraft. The input data is open-source data and may get corrupted before it reaches the flight management system. Before transmitting the real-time weather and/or traffic data (the input data) to the flight management system 806, authenticity of the input data may be verified with similar process as depicted in FIGS. 1 and 2, where the input data may be processed through multiple flight plan applications and output data obtained from each flight plan application can be coordinated to determine a confidence level between each of the output data. If the output data fails the verification test as explained in FIGS. 1 and 2, the output data is corrupted, i.e., the real-time weather and/or traffic data is contaminated. Such output data may be isolated and neutralized. If the output data passes the verification test as explained in FIGS. 1 and 2, the real-time flight data and the real-time weather and/or traffic data received from the authenticated flight plan applications may then be input into a simulation engine (not shown) to calculate any flight modification parameters. Once the simulation is completed, then any flight modification parameters may be transmitted to the aircraft crew via a communication link to the flight management system 806 where appropriate flight changes may be made to the enroute aircraft.

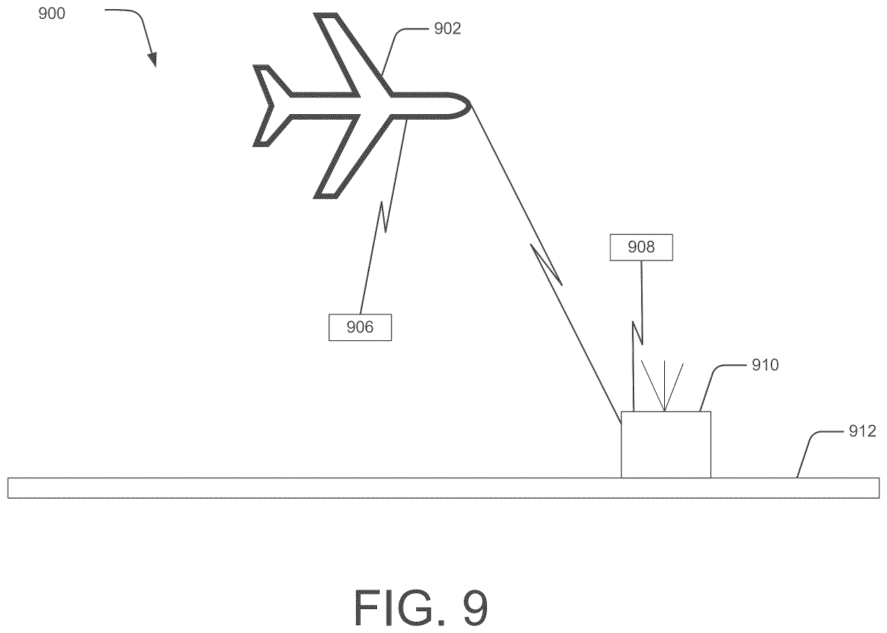

FIG. 9 depicts an environment 900 where the aircraft 902 is flying and simultaneously interacting with a ground fleet service platform 910 located at ground 912, according to an example. Firstly, in this environment 900, in an example, a system (now shown here) which is similar to the system 100 may begin with receiving from the flight management system 906 disposed onboard the aircraft, real-time flight data. The real-time flight data is the aviation data.

Further, Further, the system may then obtain an input data from the pilot of the aircraft via third party data sources 908, real-time weather and/or traffic data for the flight path of the aircraft. The input data is open-source data and may get corrupted before it reaches the flight management system. Before transmitting the real-time weather and/or traffic data (the input data) to the flight management system 906, authenticity of the input data may be verified with similar process as depicted in FIGS. 1 and 2, where the input data may be processed through multiple flight plan applications and output data obtained from each flight plan application can be coordinated to determine a confidence level between each of the output data. If the output data fails the verification test as explained in FIGS. 1 and 2, the output data is corrupted, i.e., the real-time weather and/or traffic data is contaminated. Such output data may be isolated and neutralized. If the output data passes the verification test as explained in FIGS. 1 and 2, the real-time flight data and the real-time weather and/or traffic data received from the authenticated flight plan applications may then be input into a simulation engine (not shown) to calculate any flight modification parameters. Once the simulation is completed, then any flight modification parameters may be transmitted to the aircraft crew via a communication link to the flight management system 806 where appropriate flight changes may be made to the enroute aircraft. In an example, the output data can be authenticated based on a pilot review prompt. The pilot review prompt is limited based on a mission state while airborne and insertion of a nearby waypoint can also be initiated based on the pilot review prompt.

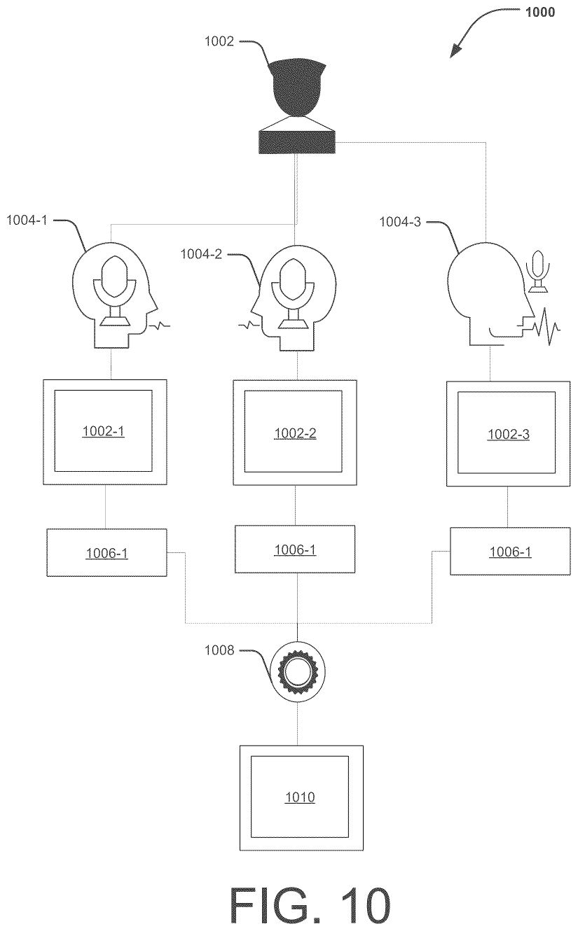

FIG. 10 illustrates an environment 1000 where an input data is processed through three flight plan applications 1002-1, 1002-2, 1002-3, according to an example. In operation, when a pilot 1002 push-in flight plans or changes to the connected flight management system, such as using an audio input as the input data, the input data may be obtained. The input data may be associated with at least one of flight assistance parameters of the aircraft. For example, the input data may be an indicative of change in flight altitude because of real-time weather conditions. The input data is further conveyed to the avionics, i.e., flight management system to implement the required changes in the flight plan based on the input data. To ensure the safety of the aircraft, the input data is processed such that the input data is only conveyed to the avionics if it is uncompromised. This is done because, the input data may be compromised before it reaches to the avionics, for example, due to a cyber-attack. The compromised input data may be harmful for the aircraft. In an example, the environment 1000 may include a set of translator applications 1004-1, 1004-2, and 1004-3 that issue the input data for each of the flight plan applications 1002-1, 1002-2, 1002-3. In an example, the translator applications may be heterogeneous. The translator application is to translate the input data to a format processable by respective flight plan applications. Each flight plan application accepts input data in a specific format. Therefore, the translator applications help the flight plan applications to get the input data in a desired format.

Upon obtaining the input data, the obtained input data may be processed at each of a predetermined number of flight plan applications 1002-1, 1002-2, 1002-3. In an example, all the flight plan applications 1002-1, 1002-2, 1002-3 may be heterogeneous. The heterogenous processing of the input data increases the trust level that avionics can place on the data sourced from flight plan applications 1002-1, 1002-2, 1002-3. The heterogenous processing obviates the disadvantages of common path processing of the input data. Each flight plan application independently processes the input data, and output data is obtained from each of the flight plan applications 1002-1, 1002-2, 1002-3 at its respective receivers 1006-1, 1006-2, 1006-3. Therefore, the output data obtained from each of the flight plan applications can be checked to ensure the authenticity of the output data. If the input data is processed through different flight plan applications, then the output data from each of the different flight plan applications 1002-1, 1002-2, 1002-3 is a reliable variable to check the authenticity.

Further, a confidence level of the output data received from each of the receivers 1006-1, 1006-2, 1006-3 for checking the output data authenticity is determined at a grading unit 1008. In an example, such a determination may be made depending on a degree of agreement between the output data. In an example, such a determination may be made depending on a degree of disagreement between the output data. The confidence level is associated with a data acceptability level. The degree of agreement is an indicative of similarity in the output data from different sources. The higher is the confidence level, the higher is the data acceptability level and lower is the chance that the output data is corrupted or compromised. In an example, the degree of agreement is directly proportional to the confidence level. The degree of disagreement is an indicative of dissimilarity in the output data from different sources. The lower is the confidence level, the lower is the data acceptability level and higher is the chance that the output data is corrupted or compromised. The lower confidence level, i.e., higher degree of disagreement is an indicative that the output data that may include a malicious program, modified data, etc., which on execution may cause irregularity in the functioning of the avionics, i.e. flight management system. For determining the confidence level of the output data, a number of similar output data P_{AGREE} from the flight plan applications is determined by the grading unit 1008. Further, a total number of output data P_{TOTAL} received from the flight plan applications is determined by the grading unit 1008. Further, the confidence level is computed by the grading unit 1008 in percentage by dividing the number of similar output data with the total number of output data and further multiplying by hundred, i.e., confidence level (percentage acceptance)=(P_{AGREE}/P_{TOTAL})*100.

After determining the confidence level, the grading unit 1008 may compare the determined confidence level with a prespecified threshold. The prespecified threshold may be set depending on the safety criticality. On determining based on the comparison that the determined confidence level is below the prespecified threshold, the output data is rejected, i.e., the flight management system 1010 does not accept the input data for updates in the flight plan.

On determining based on the comparison that the determined confidence level is within the prespecified threshold, the flight management system 1010 accept the output data for calculating flight modification parameters using the output data. In an example, the flight modification parameters may comprise at least one of an increase in speed, a decrease in speed, an increase in altitude, a decrease in altitude, and a change in flight route of the aerial vehicle.

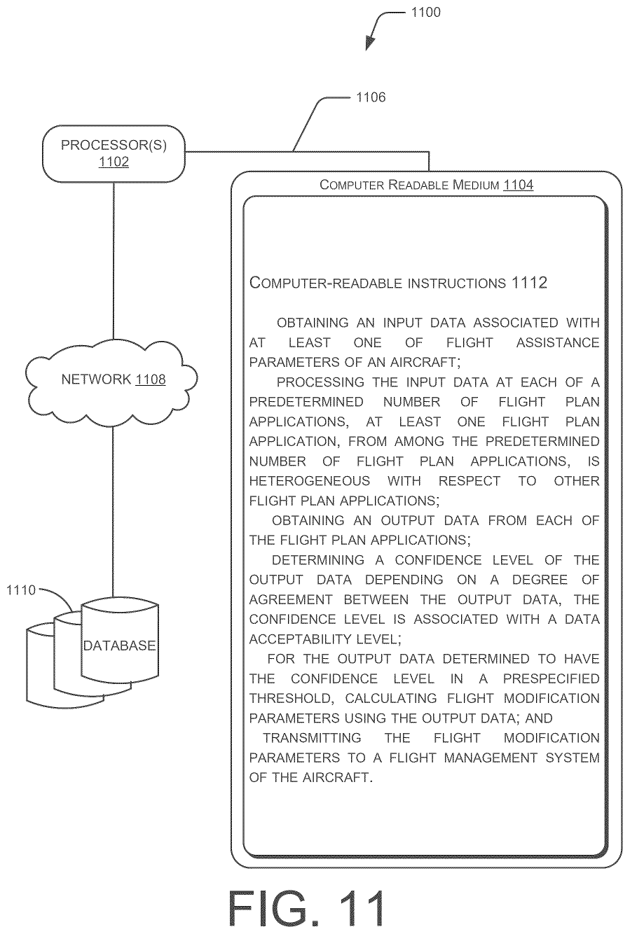

FIG. 11 illustrates a system environment 1100 implementing a non-transitory computer readable medium for managing security of data to be used with avionics, according to an example. In an example, the system environment 1100 includes processor(s) 1102 communicatively coupled to a non-transitory computer readable medium 1104 through a communication link 1006. In an example, the processor(s) 1102 may have one or more processing resources for fetching and executing computer-readable instructions from the non-transitory computer readable medium 1104. The processor(s) 1102 and the non-transitory computer readable medium 1004 may be implemented, for example, in the system 100 (as has been described in conjunction with the preceding figures).

The non-transitory computer readable medium 1104 may be, for example, an internal memory device or an external memory device. In an example implementation, the communication link 1106 may be a network communication link. The processor(s) 1102 may access the non-transitory computer readable medium 1104 through a network 1108. The network 1108 may be a single network or a combination of multiple networks and may use a variety of communication protocols. The processor(s) 1102 and the non-transitory computer readable medium 1104 may also be communicatively coupled to a data source 1110 over the network 1108. The data source 1110 may include, for example, a database.

In an example implementation, the non-transitory computer readable medium 1104 includes a set of computer readable instructions (hereinafter may also be referred as instructions) 1112 which may be accessed by the processor(s) 1102 through the communication link 1006. Referring to FIG. 11, in an example, the non-transitory computer readable medium 1104 includes instructions 1112 that may cause the processor(s) 1102 to obtain the input data from a user directly or from the user via the EFB. In an example, the input data may be received from a pilot. In an example, the user may be pilot of the aircraft. In an example, the user may a crew member of the aircraft. In an example, the user may an operator sitting at an air traffic control unit. In an example, the input data can be an audio input. In an example, the input data can be a text input. In an example, the input data may be received from an EFB. For example, in case of a connected flight management system, the pilot may push-in flight plans or changes to the connected flight management system, such as using an audio input as the input data. The input data is associated with a flight assistance parameter of an aircraft such as real-time weather information which may be obtained from a network. The flight assistance parameter assists in optimizing the flight plan of the aircraft. In an example, the input data may be referring to change in flying altitude, for example, from 10000 feet to 12000 feet. In an example, the input data may be updated weather details at different time periods. Upon receiving the input data, the instructions 1112 may cause the processor(s) 1102 to process the obtained input data at each of a predetermined number of flight plan applications. In an example, the flight plan applications are EFB applications. It is ensured that at least one flight plan application, from among the predetermined number of flight plan applications, is heterogeneous with respect to other flight plan applications. In an example, all the flight plan applications may be heterogeneous. The heterogenous processing of the input data increases the trust level that avionics can place on the data sourced from flight plan applications, i.e., EFB applications. The heterogenous processing obviates the disadvantages of common path processing of the input data. Each flight plan application independently processes the input data, and further the instructions 1112 may cause the processor(s) 1102 to obtain output data from each of the flight plan applications. Therefore, the output data obtained from each of the flight plan applications can be checked to ensure the authenticity of the output data. Before transmitting the processed data, i.e., output data to the avionics, the output data is checked to confirm the authenticity of the output data so that the avionics can be prevented from receiving any corrupted data. The corrupted data may include a malicious program, a virus, modified data, and/or any suspicious data.

Therefore, the instructions 1112 may cause the processor(s) 1102 to determine a confidence level of the output data for checking the output data authenticity. Such a determination may be made depending on a degree of agreement between the output data. The confidence level is associated with a data acceptability level. The degree of agreement is an indicative of similarity in the output data from different sources. The higher is the confidence level, the higher is the data acceptability level and lower is the chance that the output data is corrupted or compromised. In an example, the degree of agreement is directly proportional to the confidence level. On the other hand, the lower confidence level is an indicative that the output data that may include a malicious program, modified data, etc., which on execution may cause irregularity in the functioning of the avionics, i.e. flight management system.

On determining that the output data have the confidence level in a prespecified threshold, the instructions 1112 may cause the processor(s) 1102 to calculate flight modification parameters using the processed output data. In an example, if the output data from all sources, i.e., all the flight plan applications agree with each other with a confidence level of 100%, the output data is accepted for further processing. The instructions 1112 may cause the processor(s) 1102 to transmit the flight modification parameters to the flight management system of the aircraft for continuing optimal flight operation of the aircraft. In an example, the flight modification parameters may comprise at least one of an increase in speed, a decrease in speed, an increase in altitude, a decrease in altitude, and a change in flight route of the aerial vehicle. The flight management system is at least one of an onboard flight management system located onboard the aircraft or a remote flight management system located remotely from the aircraft, and the flight modification parameters are received from at least one of the onboard flight management system onboard or the remote flight management system.

The instructions 1112 may further cause the processor(s) 1102 to reject the output data determined to have the confidence level below the prespecified value.

The instructions 1112 may further cause the processor(s) 1102 to verify a nearby waypoint to the output data to authenticate context sensitivity of the output data. The nearby waypoint is an indicator associated with a flight plan summary. For example, if the output data is related to distance shortening then fuel parameter may be checked to authenticate context sensitivity of the output data.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

We claim:

1. A method comprising:
obtaining an input data associated with at least one of flight assistance parameters of an aircraft;
processing the input data at each of a predetermined number of flight plan applications, wherein at least one flight plan application, from among the predetermined number of flight plan applications, is heterogeneous with respect to other flight plan applications;
obtaining an output data from each of the flight plan applications;
determining a confidence level of the output data depending on a degree of agreement between the output data, wherein the confidence level is associated with a data acceptability level;
for the output data determined to have the confidence level in a prespecified threshold, calculating flight modification parameters using the output data; and
transmitting the flight modification parameters to a flight management system of the aircraft.

2. The method as claimed in claim 1, further comprising:
verifying a nearby waypoint to the output data to authenticate context sensitivity of the output data when the output data is determined to have the confidence level below the prespecified threshold, wherein the nearby waypoint is an indicator associated with a flight plan summary.

3. The method as claimed in claim 2, wherein the flight plan summary comprises one or more of fuel, distance, travel route, and travel time.

4. The method as claimed in claim 1, further comprising rejecting the output data determined to have the confidence level below the prespecified threshold.

5. The method as claimed in claim 1, wherein the processing of the input data comprises independently processing the input data at each of the flight plan applications.

6. The method as claimed in claim 1, wherein the determining of the confidence level of the output data comprises:
determining number of similar output data;
determining total number of output data received from the flight plan applications; and
computing the confidence level in percentage by dividing the number of similar output data with the total number of output data and further multiplying by hundred.

7. The method as claimed in claim 6, further comprising calculating flight modification parameters using the output data, when the output data is determined to have the confidence level of 100%, wherein the confidence level of 100% indicates that the output data from each of the flight plan applications are the same.

8. The method as claimed in claim 1, further comprising initiating a pilot review prompt to authenticate context sensitivity of the output data when the output data determined to have similar values at each of the flight plan applications.

9. The method as claimed in claim 1, further comprising rejecting the output data on determining that the output data at each of the flight plan applications is different.

10. The method as claimed in claim 1, further comprising:
determining the output data having the confidence level in the prespecified threshold as graded data;
transmitting the graded data to each of the flight plan applications;
ascertaining if the graded data is an actual output corresponding to the input data received for the processing at each of the flight plan applications; and
authenticating the graded data as valid data.

11. The method as claimed in claim 1, further comprising:
obtaining a feedback for each of the flight plan applications based on computation of the output data at each of the flight plan applications;
updating weightage of each of the flight plan applications based on the feedback; and
determining the confidence level of the output data depending on the degree of agreement between the output data and the updated weightage of each of the flight plan applications.

12. A system comprising:
a data processing engine to:
obtain an input data associated with at least one of flight assistance parameters of an aircraft;
process the input data at each of a predetermined number of flight plan applications, wherein at least one flight plan application, from among the predetermined number of flight plan applications, is heterogeneous with respect to other flight plan applications;
obtain an output data from each of the flight plan applications; and
determine a confidence level of the output data depending on using a degree of agreement between the output data, wherein the confidence level is associated with a data acceptability level; and
a flight parameter generation engine to:
for the output data determined to have the confidence level in a prespecified threshold, calculate flight modification parameters the output data; and
transmit the flight modification parameters to a flight management system of the aircraft.

13. The system as claimed in claim 12, wherein for the output data determined to have the confidence level below the prespecified value indicating that a degree of disagreement is present, the data processing engine is to:
authenticate the output data;
on determining that the output data is authentic, the flight parameter generation engine is to
calculate flight modification parameters using the output data; and
transmit the flight modification parameters to the flight management system of the aircraft.

14. The system as claimed in claim 13, wherein for the authentication of the output data for the output data determined to have the confidence level below the prespecified threshold, the data processing engine is to:
verify a nearby waypoint to the output data to authenticate context sensitivity of the output data, wherein the nearby waypoint is an indicator associated with a flight plan summary.

15. The system as claimed in claim 14, wherein the flight plan summary comprises one or more of fuel, distance, travel route, and travel time.

16. The system as claimed in claim 12, wherein the data processing engine is to reject the output data determined to have the confidence level below the prespecified threshold.

17. The system as claimed in claim 12, further comprising a feedback engine to:
obtain a feedback for each of the flight plan applications based on computation of the output data at each of the flight plan applications; and
update weightage of each of the flight plan applications based on the feedback, wherein the data processing engine is to determine the confidence level of the output data depending on the degree of agreement between the output data and the updated weightage of each of the flight plan applications.

18. A non-transitory computer readable medium having instructions stored thereon, the instructions, when executed by a processor, cause the processor to perform operations comprising:
obtaining an input data associated with at least one of flight assistance parameters of an aircraft;
processing the input data at each of a predetermined number of flight plan applications, wherein at least one flight plan application, from among the predetermined number of flight plan applications, is heterogeneous with respect to other flight plan applications;
obtaining an output data from each of the flight plan applications;
determining a confidence level of the output data depending on a degree of agreement between the output data, wherein the confidence level is associated with a data acceptability level;
for the output data determined to have the confidence level in a prespecified threshold, calculating flight modification parameters using the output data; and
transmitting the flight modification parameters to a flight management system of the aircraft.

19. The non-transitory computer readable medium as claimed in claim 18, further comprising verifying a nearby waypoint to the output data to authenticate context sensitivity of the output data, wherein the nearby waypoint is an indicator associated with a flight plan summary.

20. The non-transitory computer readable medium as claimed in claim 18, further comprising rejecting the output data determined to have the confidence level below the prespecified value.
